(19) United States
(12) Patent Application Publication
(10) Pub. No.: US 2025/0337200 A1
(43) Pub. Date: Oct. 30, 2025

(54) ADVANCED GROUNDING CONNECTOR FOR ENHANCED SIGNAL INTEGRITY

(71) Applicant: Molex, LLC, Lisle, IL (US)

(72) Inventors: John C. Laurx, Aurora, IL (US); Jose J. Gonzalez, Jr., Joliet, IL (US); Khang Choong Yong, Selangor (MY); William J. Miller, II, New Lenox, IL (US); Marc E Krause, Darien, IL (US)

(21) Appl. No.: 19/090,448

(22) Filed: Mar. 26, 2025

Related U.S. Application Data
(60) Provisional application No. 63/638,437, filed on Apr. 25, 2024.

(51) Int. Cl. H01R 13/648; H01R 24/84

(52) U.S. Cl. CPC H01R 13/6485; H01R 24/84

(57) ABSTRACT

An input/output (I/O) connector without first-mate, last-break (FMLB) functionality is disclosed. The connector includes a housing having a wafer assembly that includes differential terminal pairs. The connector further includes a first set of ground terminals and a second set of ground terminals, the first set and the second set of ground terminals extending above a top-most end of the plurality of differential pairs. The first set of ground terminals can be configured to avoid deflection upon contact, and the second set of ground terminals can be configured to deflect upon contact.

### TECHNICAL FIELD

The present disclosure generally relates to the field of electrical connectors, and, in particular, to connectors with advanced grounding features for enhanced signal integrity and performance.

### BACKGROUND

A range of input/output (I/O) connectors are designed for power, data, and power and data interconnect systems, including board-to-board, wire-to-wire, and wire-to-board systems. A variety of designs exist for each type of system, depending on the requirements of the power and data communications environment in which the connectors are used. For high data rate applications in which physical space is constrained, as one example, it can be challenging to design interconnection system connectors due to a number of competing concerns. High data rate interconnection systems often rely upon differentially coupled signal pairs in which two conductors are arranged in a pair to transmit a differential signal. The signal being transmitted is embodied by the electrical difference measured between the conductor pair.

Differential signaling can be helpful to avoid spurious signals and crosstalk and avoid inadvertent signaling modes among adjacent signals pairs. In connector interfaces, ground terminals can be relied upon to create a return path to electrical ground, provide shielding between differential pairs, and for other purposes. Connectors used in high data rate applications are typically designed to meet a range of mechanical and electrical requirements. High data rate connectors often require very high conductor density and data rates. To achieve desired mechanical and electrical requirements, connectors used in such applications often incorporate one or more wafer assemblies.

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to a first aspect, a connector assembly is described that includes a hermaphroditic connector. The hermaphroditic connector includes: a housing including a wafer assembly, the wafer assembly including a plurality of differential terminal pairs; a first set of advanced ground terminals positioned on a first end of the housing; and a second set of advanced ground terminals positioned on a second end of the housing opposite the first end. The first set and the second set of advanced ground terminals have ends that extend above top-most ends of the plurality of differential pairs.

The first set of advanced ground terminals are configured to avoid deflection upon contact, and the second set of advanced ground terminals are configured to deflect upon contact. The first set of advanced ground terminals includes a first advanced ground terminal positioned at a first corner of the first end of the housing, and a second advanced ground terminal positioned a second corner of the first end of the housing. The second set of ground terminals includes a first advanced ground terminal positioned at a first corner of the second end of the housing, and a second advanced ground terminal positioned a second corner of the second end of the housing.

The connector assembly further includes one or more commoning bars formed of a conductive material. Each commoning bar includes a plurality of projections that engage with apertures in the wafer assembly, where at least a portion of the first set of advanced ground terminals and the second set of advanced ground terminals are conductively coupled to the commoning bar. The commoning bar can be a first commoning bar positioned on a first lateral side of the housing, where the connector assembly includes a second commoning bar positioned on a second lateral side of the house opposite the first side.

The wafer assembly includes a plurality of grounding components formed of a conductive material. At least a portion of the conductive material is exposed through the apertures in the wafer assembly, and is conductively coupled to the commoning bar. The first set of advanced ground terminals includes a body having a hooked top contact portion and a lower twisted portion positioned parallel to the second end of the housing. The lower twisted portion of the first set of advanced ground terminals extends parallel with the lateral side of the hermaphroditic connector and contacts the commoning bar.

The second set of advanced ground terminals comprises a body formed of a member extending along a vertical axis of the hermaphroditic connector. The member has a bent contact portion positioned parallel to the first end of the housing. The body further includes a lower twisted portion that extends parallel with a lateral side of the hermaphroditic connector, where the body contacts the commoning bar. In some aspects, the lower twisted portion comprises inwardly-bent members that pinch the commoning bar therebetween to form an interference connection between the body of the second set of advanced ground terminals and the commoning bar.

The hermaphroditic connector can be a first hermaphroditic connector and the connector assembly can further include a second hermaphroditic connector the same as or substantially similar to the first hermaphroditic connector. The first set of advanced ground terminals of the first hermaphroditic connector is configured to contact a second set of advanced ground terminals of the second hermaphroditic connector. The second set of advanced ground terminals of the first hermaphroditic connector is configured to contact the first set of advanced ground terminals of the first hermaphroditic connector.

According to a second aspect, a connector is described, including: a housing including a wafer assembly, the wafer assembly having a plurality of terminals; a first set of advanced ground terminals positioned on a first end of the housing; and a second set of advanced ground terminals positioned on a second end of the housing opposite the first end. The first set and the second set of advanced ground terminals extend above a top-most end of the plurality of differential pairs. The first set of advanced ground terminals are configured to avoid deflection upon contact, and the second set of advanced ground terminals are configured to deflect upon contact.

The first set of advanced ground terminals includes a first advanced ground terminal positioned at a first corner of the first end of the housing, and a second advanced ground terminal positioned a second corner of the first end of the housing. The second set of advanced ground terminals includes a first advanced ground terminal positioned at a first corner of the second end of the housing, and a second advanced ground terminal positioned a second corner of the second end of the housing.

The connector can further include a commoning bar formed of a conductive material, where at least a portion of the first set of advanced ground terminals and the second set of advanced ground terminals are conductively coupled to the commoning bar. The commoning bar includes a plurality of projections that engage with apertures in the wafer assembly to retain a plurality of wafers in the housing. The wafer assembly includes a plurality of grounding components formed of a conductive material. At least a portion of the conductive material is exposed through the apertures in the wafer assembly and is conductively coupled to the commoning bar.

The first set of advanced ground terminals comprises a body having a hooked top contact portion and a lower twisted portion positioned parallel to the second end of the housing, and the lower twisted portion of the second set of advanced ground terminals extends parallel with the lateral side of the hermaphroditic connector and contacts the commoning bar.

The second set of advanced ground terminals includes a body formed of a member extending along a vertical axis of the hermaphroditic connector. The member has a bent contact portion positioned parallel to the first end of the housing, and the body further includes a lower twisted portion that extends parallel with a lateral side of the hermaphroditic connector, the body contacting the commoning bar. The lower twisted portion includes inwardly-bent members that pinch the commoning bar therebetween to form an interference connection between the body of the second set of advanced ground terminals and the commoning bar. The first set and the second set of advanced ground terminals extend approximately 1.5 mm above the terminals of the wafer assembly.

According to a third aspect, a connector is described, including: a housing comprising a wafer assembly, the wafer assembly comprising a plurality of wafers supporting a plurality of terminals; a first set of advanced ground terminals positioned on a first end of the housing, and a second set of advanced ground terminals positioned on a second end of the housing opposite the first end; and a first commoning bar positioned on a first lateral side of the housing, and a second commoning bar positioned on a second lateral side of the housing opposite the first lateral side.

Respective ones of the first set of advanced ground terminals and the second set of advanced ground terminals are conductively coupled to the first commoning bar, and respective ones of the first set of advanced ground terminals and the second set of advanced ground terminals are conductively coupled to the second commoning bar. Each of the plurality of wafers comprises a wafer overmold that has openings on each side that exposes an integrated wafer ground structure. The first commoning bar and the second commoning bar are conductively coupled to the integrated wafer ground structure through the openings.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a top perspective view of a hermaphroditic connector in accordance with various embodiments of the present disclosure.

FIG. 2 is a bottom perspective view of the hermaphroditic connector of FIG. 1 in accordance with various embodiments of the present disclosure.

FIG. 3 is another top perspective view of the hermaphroditic connector of FIG. 1 in accordance with various embodiments of the present disclosure.

FIG. 4 is a perspective view of the hermaphroditic connector of FIG. 1 with a housing thereof omitted in accordance with various embodiments of the present disclosure.

FIG. 5 is an enlarged view of a portion of the terminal array showing a first set of advanced ground terminals in accordance with various embodiments of the present disclosure.

FIG. 6 is an enlarged view of another portion of the terminal array showing a second set of advanced ground terminals in accordance with various embodiments of the present disclosure.

FIG. 7 is a perspective view of a connector assembly comprising two hermaphroditic connectors coupled to one another in accordance with various embodiments of the present disclosure.

FIG. 8 is a perspective view of the connector assembly comprising two hermaphroditic connectors coupled to one another in accordance with various embodiments of the present disclosure.

FIG. 9 is a cross-sectional view of the connector assembly comprising two hermaphroditic connectors showing advanced grounding in accordance with various embodiments of the present disclosure.

FIG. 10 is a side view of an advanced ground terminal of the first set of advanced ground terminals in accordance with various embodiments of the present disclosure.

FIG. 11 is a side view of an advanced ground terminal of the second set of advanced ground terminals in accordance with various embodiments of the present disclosure.

FIG. 12 is a perspective view of the advanced ground terminal with a callout region showing a commoning bar in accordance with various embodiments of the present disclosure.

### DETAILED DESCRIPTION

The present disclosure relates to an advanced grounding connector for enhanced signal integrity. Differential signaling is often employed in I/O connectors to avoid spurious signals and crosstalk and avoid inadvertent signaling modes among adjacent signals pairs. In connector interfaces, ground terminals can be relied upon to create a return path to electrical ground, provide shielding between differential pairs, and for other purposes. Connectors used in high data rate applications are typically designed to meet a range of mechanical and electrical requirements. High data rate connectors often require very high conductor density and data rates. To achieve desired mechanical and electrical requirements, connectors used in such applications often incorporate one or more wafer assemblies of a particular geometry. Designing I/O connectors, however, can be difficult to achieve for high-data rate applications. For instance, non-ideal placement of terminals in wafer assemblies can cause signal interference, generate heat or electrostatic discharge (ESD), and create crosstalk and noise.

Evolving system architectures desiring to offer high-frequency bandwidth via I/O connectors often require that ground connectivity be established before high-speed signal contacts in order to provide improved electrostatic discharge protection. Advanced grounding can be achieved within a differential pair design by extending a ground mate or by adjusting signal connectivity. However, altering critical signal-to-ground relationship within high-speed differential pairs may make the connector not feasible for particular applications, and signal integrity performance may be degraded.

Accordingly, various embodiments for a connector assembly are described having advanced ground terminals separate from those critical to high-speed signal performance. In some embodiments, advanced ground terminals can be placed at connector corners to isolate the advanced ground terminals from differential pairs and to minimize any impact to signal integrity performance. Additionally, the advanced ground terminals can be integrated into a digital ground structure of each wafer and differential pair to provide additional grounding and electrostatic discharge protection.

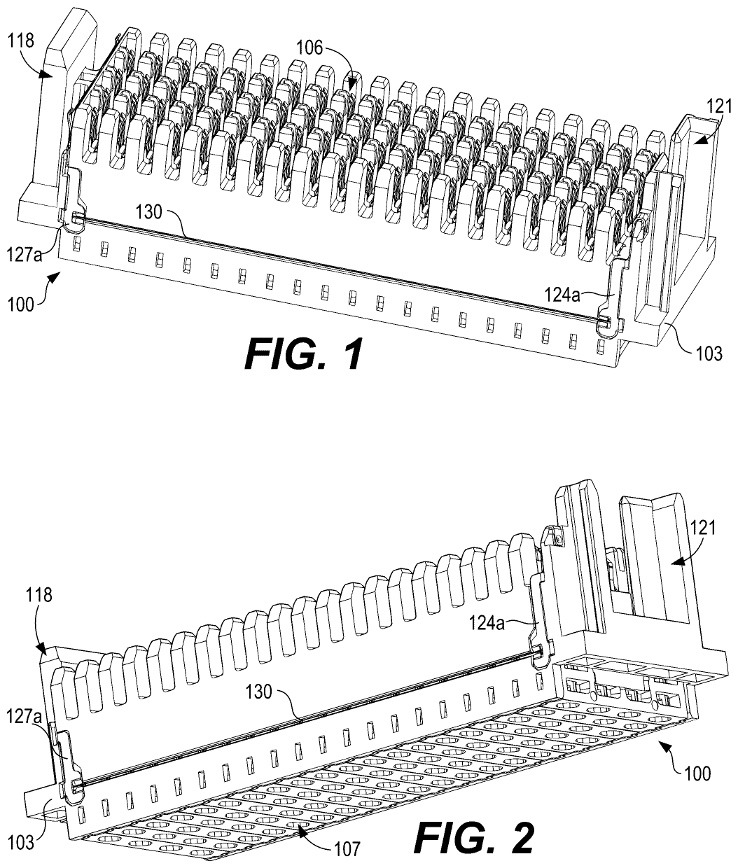

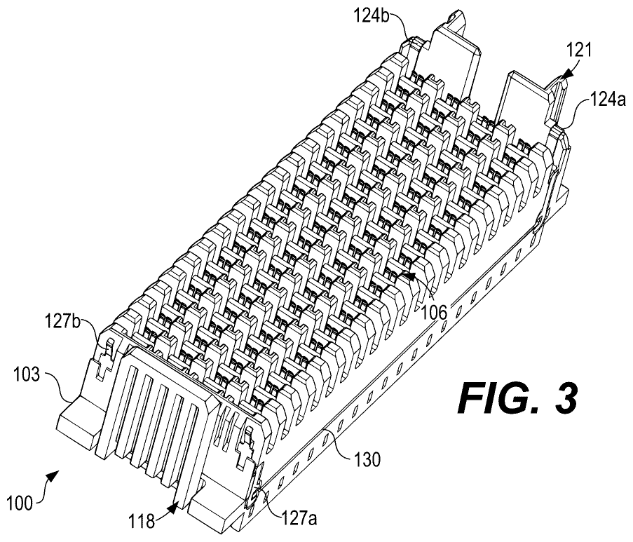

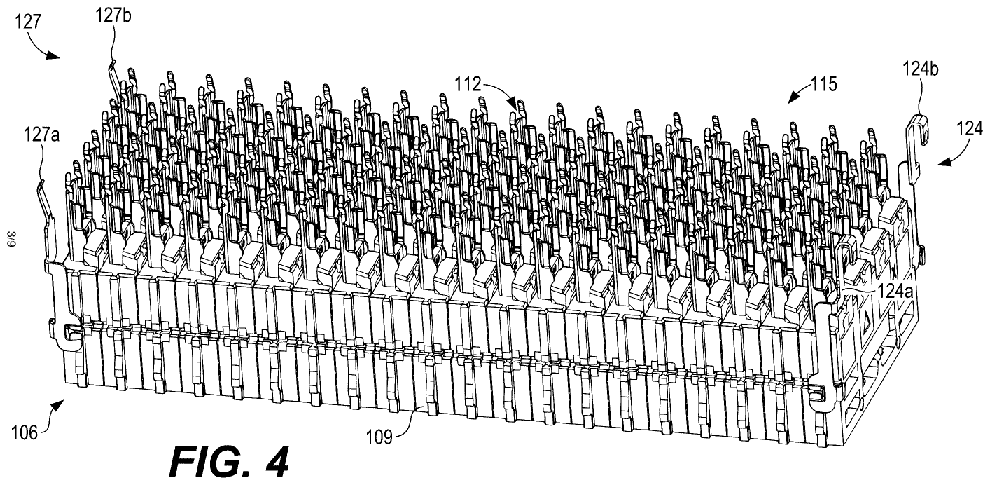

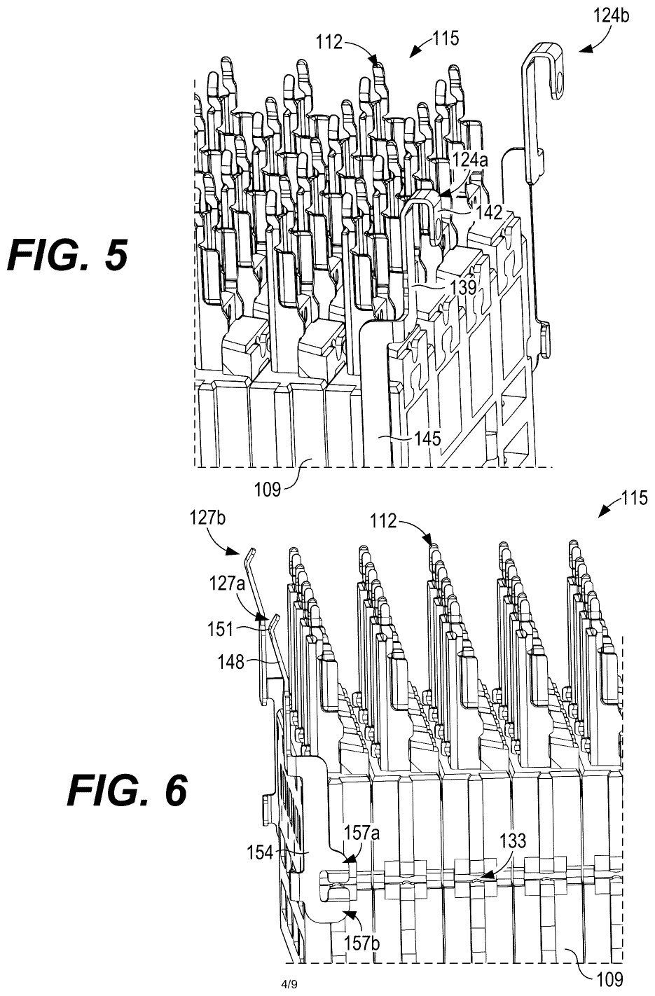

Turning now to the drawings, FIG. 1 shows a top perspective view of a hermaphroditic connector 100 (or generally “connector 100”) according to various embodiments of the present disclosure. FIGS. 2 and 3 show a bottom perspective view and another top perspective view thereof, respectively. FIG. 4 shows a wafer assembly of the hermaphroditic connector 100 of FIGS. 1-3 by omitting a housing of the connector 100 for explanatory purposes. FIGS. 5 and 6 show enlarged perspective view of various portions of the terminal array of FIG. 3.

Referring to FIGS. 1-6 collectively, a hermaphroditic connector 100 is disclosed that can include a housing 103 that surrounds and supports a wafer assembly 106 for coupling the connector 100 to another like connector or module. The housing 103 can receive or otherwise be coupled to a multitude of wires (not shown) that can be received through bottom apertures 107 in the housing 103. The housing 103 can be formed of a non-conductive polymer material, and can be injection molded around the wafer assembly 106 and/or wires in some embodiments.

The wafer assembly 106 can include a stack of individual wafers 109 or modules, each of which contain one or more electrical terminals 112 or contacts. The wafers 109 can be formed of an insulating material, and can be configured to hold and align the terminals 112 in a precise arrangement to provide an array of terminals 112, also referred to as a terminal array 115. The terminals 112 within the wafer assembly 106 can include signal, power, and ground contacts, and can be arranged in pairs or groups to facilitate differential signaling or to meet other electrical requirements, as can be appreciated. The terminals 112 can include a multitude of differential terminal pairs in some embodiments, as can be appreciated. The terminals 112 can be paired with ground terminals, shields, U-shields defining U-channels, and so forth, as can be appreciated.

In some embodiments, the housing 103 can include various components to couple the housing 103 to another housing. For example, in some embodiments, the housing 103 can include a projection tab 118 and a projection receptacle 121, although other coupling components can be employed. The projection receptacle 121 can be sized and positioned to retain a projection tab 118 therein via an interference or snap connection. Thus, when mated to a same or substantially similar connector, the projection tab 118 of a first connector 100 can be positioned in the projection receptacle 121 of a second connector 100, and the projection tab 118 of the second connector 100 can be positioned in the projection receptacle 121 of the first connector 100.

According to various embodiments, the connector 100 can include a first set of advanced ground terminals 124a, 124b (collectively “advanced ground terminals 124”) positioned on a first distal end of the housing 103, as well as a second set of advanced ground terminals 127a, 127b (collectively “advanced ground terminals 127a, 127b) positioned on a second distal end of the housing 103. As can be seen in FIG. 4 where the housing 103 is omitted for explanatory purposes, the first set of advanced ground terminals 124 can be positioned at a first end of the wafer assembly 106, and the second set of advanced ground terminals 127 can be positioned at a second end of the wafer assembly 106 opposite the first end.

The first set of advanced ground terminals 124 and/or the second set of advanced ground terminals 127 can have a length or can be otherwise positioned such that the advanced ground terminals 124, 127 have ends that extend above a top-most end of the interior terminals 112 of the terminal array 115. Thus, when the connector 100 is coupled to a same or substantially similar connector 100, the advanced ground terminals 124, 127 contact one another before the terminals 112 make contact with corresponding terminals, and vice versa on decoupling, thereby providing a first-mate, last-break interface. This can improve signal performance of the connector 100 as grounding is established prior to signal connectivity, and can improve electrostatic discharge performance.

The first set of advanced ground terminals 124 can include a first advanced ground terminal 124a positioned at a first corner of the first end of the housing 103, and a second advanced ground terminal 124b positioned a second corner of the first end of the housing 103. The second set of advanced ground terminals 127 can include a first advanced ground terminal 127a positioned at a first corner of the second end of the housing 103, and a second advanced ground terminal 127b positioned a second corner of the second end of the housing 103. The location of the advanced ground terminals 124, 127 can be placed at connector corners in some embodiments to isolate the advanced ground terminals 124, 127 from differential terminals 112 and to minimize any impact to signal integrity performance.

While various embodiments described herein include advanced ground terminals 124, 127 positioned at four corners of the housing 103, the disclosure is not so limited, and the locations of the advanced ground terminals 124, 127 can be changed or otherwise adjusted without deviating from the scope of the present disclosure. Additionally, while various embodiments show four of the advanced ground terminals 124, 127, it is understood that other numbers of the advanced ground terminals 124, 127 can be employed.

In some aspects, the connector 100 can include a commoning bar 130 positioned on one or both of the lateral sides of the connector 100. For instance, a first commoning bar 130 can be positioned on a first lateral side of the connector 100, whereas a second commoning bar 130 can be positioned on a second lateral side of the connector 100 opposite the first lateral side. The commoning bar 130 can be formed of a conductive material in some embodiments, such as copper, aluminum, or like material.

In some embodiments, the commoning bar 130 includes a longitudinally extending body having a multitude of projections. The projections can be inserted into corresponding apertures 133 on the wafers 109, providing additional stability and rigidity to the overall connector, and providing improved grounding. In some embodiments, one or more of the advanced ground terminals 124, 127 can be conductively coupled to the commoning bar 130. For instance, advanced ground terminal 124a and/or advanced ground terminal 127a can be coupled to a first commoning bar 130 positioned on a first lateral side of the connector 100, whereas advanced ground terminal 124b and/or advanced ground terminal 127b can be coupled to a second commoning bar 130 positioned on a second lateral side of the connector 100.

According to various embodiments, the first set of advanced ground terminals 124 can include static terminals. In other words, the first set of advanced ground terminals 124 can be configured to avoid deflection upon contact. Referring specifically to FIG. 5, the first set of advanced ground terminals 124 can include a body 139 having a hooked top contact portion 142 and a lower twisted portion 145. The hooked top contact portion 142 can be hooked around or otherwise positioned in the housing 103 such that the advanced ground terminals 124 are substantially fixed or rigid. To this end, the housing 103 can be overmolded on the advanced ground terminal 124 in some embodiments. The body 139 of the advanced ground terminals 124 can be positioned parallel to the second end of the housing 103, and the lower twisted portion 145 of the first set of advanced ground terminals 124 can twist to extend parallel to the lateral side of the hermaphroditic connector 100 and contact the commoning bar 130.

According to various embodiments, the second set of advanced ground terminals 127 can be dynamic or flexing terminals. In other words, the second set of advanced ground terminals can be configured to deflect or flex upon contact. Referring specifically to FIG. 6, the second set of advanced ground terminals 127 can include a body 148 extending vertically along a vertical axis of the connector 100 that is positioned parallel to the first end of the housing 103. In some embodiments, the body 148 can include a bent contact portion 151. Due to the bent nature of the body 148, the second set of advanced ground terminals 127 will deflect upon contact.

The bent contact portion 151 can have a shape similar to those of the terminals 112, as can be appreciated. Like the first set of advanced ground terminals 124, the body 148 of the second set of advanced ground terminals 127 can further include a lower twisted portion 154 that twists relative to an upper portion of the body 148, and extends parallel with a lateral side of the connector 100. The lower twisted portion 154 can contact the commoning bar 130, which is omitted from FIG. 6 for explanatory purposes.

As can be seen in FIG. 6, the lower twisted portion 154 of each of the advanced ground terminals 124, 127 can include inwardly-bent members 157a, 157b (collectively “inwardly-bent members 157”). The inwardly-bent members 157a, 157b can be bent towards the wafers 109 and can pinch the commoning bar 130 therebetween to form an interference connection between the body of the advanced ground terminals 124, 127 and a respective one of the commoning bars 130. In some embodiments, ground terminals, U-shields, or other commoning components of a wafer 109 can be formed of a conductive material, where at least a portion of the conductive material can be exposed in the aperture 133 of the wafer 109. The projections of the commons bar 130 can extend through the aperture 133 to make contact with the conductive material, thereby providing additional grounding.

For instance, a wafer overmold of a wafer 109 can include an aperture or other opening on each side that exposes an integrated wafer ground structure that facilitates connection with the one or more commoning bars 130. Thus, the one or more commoning bars 130 can be conductively coupled to the integrated wafer ground structure through the apertures 133. Thus, the advanced ground terminals 124, 127, the commoning bars 130, and the ground terminals of the terminal array 115 can be grounded to one another in some implementations. As such, the advanced ground terminals 124, 127 can be integrated into a digital (logic) ground structure of each wafer 109 and/or each differential terminal pair to provide electrostatic discharge protection.

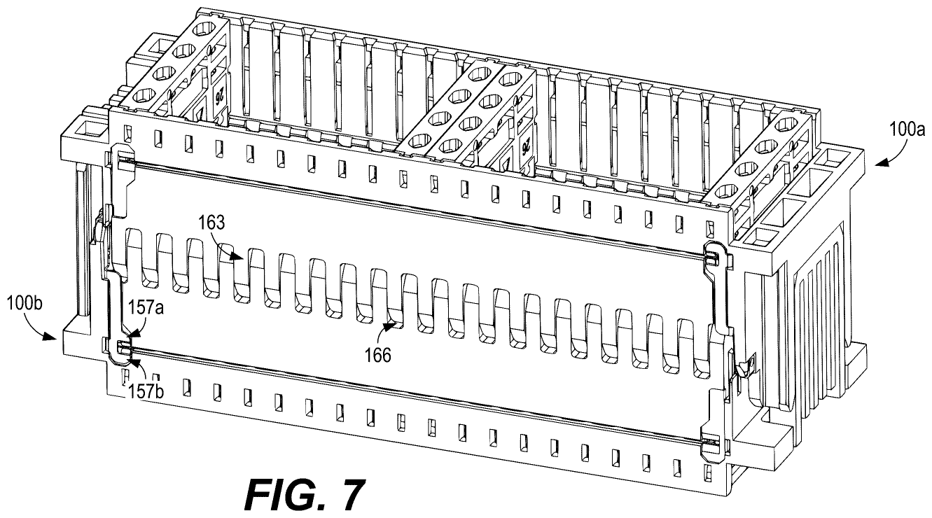

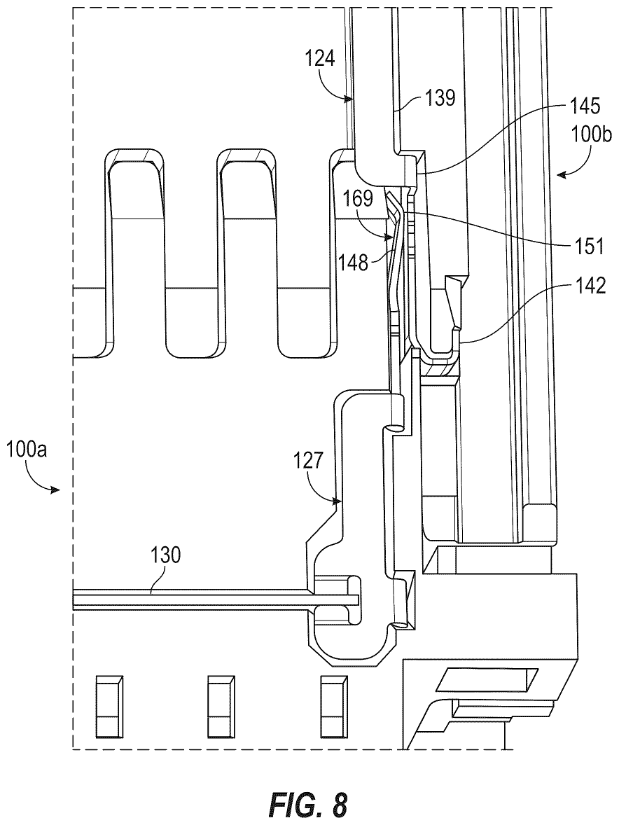

Turning now to FIGS. 7 and 8, a first hermaphroditic connector 100a is shown being coupled to a second hermaphroditic connector 100b. The housing 103 includes projections 163 extending from the housing 103 around the terminal array 115. The projections 163, when the connectors 100a, 100b are coupled, nest within apertures 166 positioned between the projections 163.

FIG. 8 shows a fully-mated coupling of the first hermaphroditic connector 100a and the second hermaphroditic connector 100b. When the hermaphroditic connectors 100a, 100b are mated together, the dynamic terminals on the first connector 100a mate with the static terminals on the second connector 100b. More specifically, the advanced ground terminal 127 of the first connector 100a contacts the advanced ground terminal 124 of the second connector 100b, deflects, and slides into place in a nested chamber 169.

The advanced ground terminal 124 of the second connector 100b does not deflect, and provides an elongated surface for the advanced ground terminal 127 of the first connector 100a to contact and slide against until the connectors 100a, 100b are fully coupled. In some implementations, the bent contact portion 151 contacts and rests on the elongated surface of the advanced ground terminal 124 of the second connector 100b. As can be seen in FIG. 8, the advanced ground terminal 124 of the second connector 100b is coupled to the advanced ground terminal 127 of the first connector 100a which is, in turn, coupled to the commoning bar 130. The commoning bar 130 can be further coupled to grounding of the terminal arrays 115, providing substantial grounding in the connectors 100a, 100b.

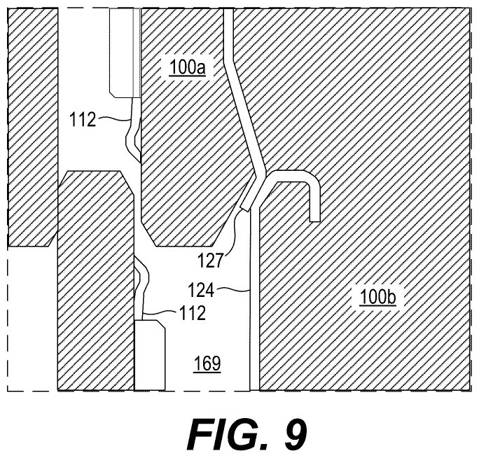

FIG. 9 shows a partially-mated coupling of the first hermaphroditic connector 100a and the second hermaphroditic connector 100b. For example, FIG. 9 shows a point in time when the first hermaphroditic connector 100a and the second hermaphroditic connector 100b are only partially coupled, for instance, at the beginning of a coupling process. As can be seen in FIG. 9, due to the size and/or positioning of the advanced ground terminals 124, 127, the advanced ground terminals 124, 127 contact one another prior to the terminals 112 of the connectors 100a, 100b.

In some embodiments, the advanced ground terminals 124, 127 extend approximately 1.5 mm above the terminals 112 of the wafer assembly 106. Thus, upon coupling, the advanced ground terminal 127 of the first connector 100a will contact the advanced ground terminal 124 of the second connector 100b prior to coupling of the terminals 112, deflect, and slide into place into the nested chamber 169. The advanced ground terminal 124 of the second connector 100b does not deflect, and provides an elongated surface for the advanced ground terminal 127 of the first connector 100a to contact and slide against until the connectors 100a, 100b are fully coupled.

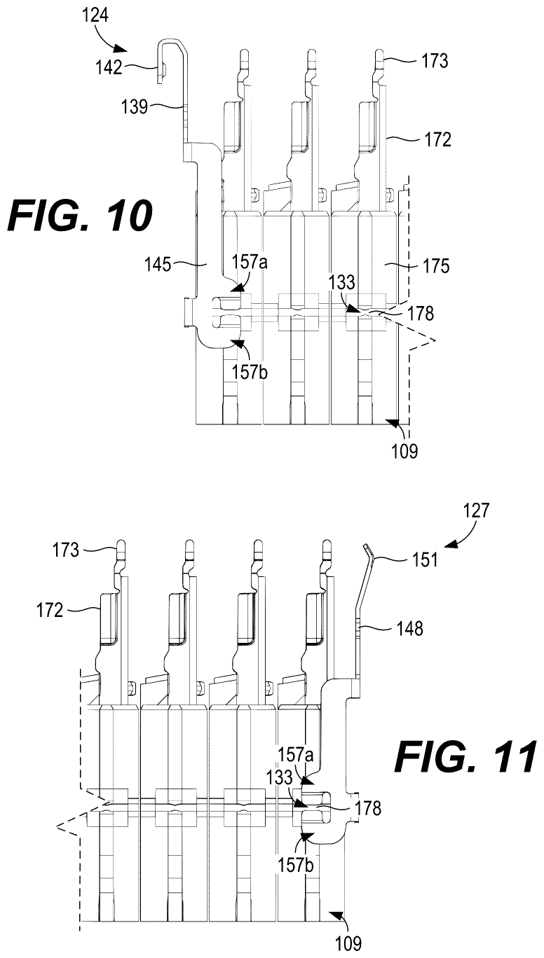

Turning now to FIG. 10, a side view of an advanced ground terminal 124 is shown according to various embodiments. The commoning bar 130 is omitted from FIG. 10 for explanatory purposes. The advanced ground terminal 124 can be static or, in other words, can avoid deflection upon contact. The advanced ground terminal 124 includes a body 139 having a hooked top contact portion 142 and a lower twisted portion 145. The hooked top contact portion 142 and/or the lower twisted portion 145 can be integral with the body 139, and can be formed via bending or like manufacturing processes, reducing the need of welding or further joining processes. The body 139 of the advanced ground terminal 124 can be positioned parallel to the second end of the housing 103.

A top-end of the advanced ground terminal 124 can extend 1.5 mm or other desired length above ends of terminals 112, where the terminals 112 are nested within U-shields 172 or like grounding components in FIGS. 10 and 11. The U-shield 172 can include ground terminals 173 where, in some embodiments, the ground terminals 173 are integral with the U-shield 172. The lower twisted portion 145 of the first set of advanced ground terminals 124 can have a ninety (90) degree turn relative to the hooked top contact portion 142 and can thus conform to a corner of the housing 103. As such, the lower twisted portion 145 of the advanced ground terminal 124 extends parallel to a lateral side of the connector 100. The lower twisted portion 145 can conductively contact the commoning bar 130, and can retain the commoning bar via the inwardly-bent members 157a, 157b or like connection mechanism.

The wafer 109 includes a wafer overmold 175 which can be formed of a non-conductive polymer material. The wafer overmold 175 can include an aperture 133 or other opening on each side that exposes an integrated wafer ground structure 178, which can be conductively coupled to the U-shield 172 as well as other grounding components of the wafer 109. The integrated wafer ground structure 178 facilitates connection with the one or more commoning bars 130. For instance, the one or more commoning bars 130 can be conductively coupled to the integrated wafer ground structure through the apertures 133 via the projections of the commoning bars 130. Thus, the advanced ground terminals 124, 127, the commoning bars 130, and the ground terminals 173 of the terminal array 115 can be grounded to one another in some implementations. As such, the advanced ground terminals 124, 127 can be integrated into a digital (logic) ground structure of each wafer 109 and/or each differential terminal pair to provide electrostatic discharge protection.

Referring now to FIG. 11, an advanced ground terminal 127 is shown that can be a dynamic or a flexing terminal that is configured to deflect or flex upon contact. The advanced ground terminals 127 include a body 148 extending vertically along a vertical axis of the connector 100 that is positioned parallel to the first end of the housing 103. In some embodiments, the body 148 can include a bent contact portion 151. Due to the bent nature of the body 148, the second set of advanced ground terminals 127 will deflect upon contact. In some embodiments, the bent contact portion 151 can be selectively plated to increase conductivity. For instance, an amount of gold, silver, or other highly conductive material can be selectively plated in an area of the bent contact portion 151 to increase conductivity.

The bent contact portion 151 can have a shape similar to those of the terminals 112, as can be appreciated. Like the first set of advanced ground terminals 124, the body 148 of the second set of advanced ground terminals 127 can further include a lower twisted portion 154 that extends parallel with a lateral side of the connector 100. The lower twisted portion 154 can contact the commoning bar 130, which is omitted from FIG. 11 for explanatory purposes.

The inwardly-bent members 157a, 157b can be bent towards the wafers 109 and can pinch the commoning bar 130 therebetween to form an interference connection between the body of the advanced ground terminals 124, 127 and a respective one of the commoning bars 130. The other side of the wafer 109 shows an aperture 133 exposing the integrated wafer ground structure 178, which is conductively coupled to the U-shield 172 or other grounding components of the wafer 109. The one or more commoning bars 130 can be conductively coupled to the integrated wafer ground structure through the apertures 133 via the projections of the commoning bars 130. Thus, the advanced ground terminals 124, 127, the commoning bars 130, and the ground terminals 173 of the terminal array 115 can be grounded to one another in some implementations. As such, the advanced ground terminals 124, 127 can be integrated into a digital (logic) ground structure of each wafer 109 and/or each differential terminal pair to provide electrostatic discharge protection.

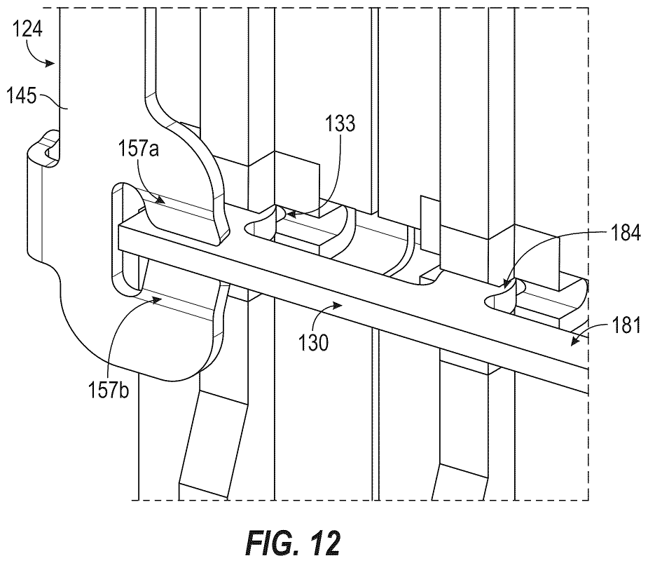

Referring now to FIG. 12, a perspective view of a connector 100 is shown where the housing 103 is omitted for explanatory purposes. Specifically, FIG. 12 shows the lower twisted portion 145 of an advanced ground terminal 124 contacting the commoning bar 130. More specifically, the lower twisted portion 145 is shown having inwardly-bent members 157a, 157b that pinch or otherwise contact the commoning bar 130 therebetween to form an interference connection between the advanced ground terminal 124 and the commoning bar 130. The commoning bar 130 includes a longitudinally extending body 181 having a multitude of projections 184. The projections can be inserted into corresponding apertures 133 on the wafers 109 to provide additional stability and rigidity to the overall connector, and provide improved grounding.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A connector assembly, comprising:
a hermaphroditic connector, comprising:
a housing comprising a wafer assembly, the wafer assembly comprising a plurality of differential terminal pairs;
a first set of advanced ground terminals positioned on a first end of the housing; and
a second set of advanced ground terminals positioned on a second end of the housing opposite the first end,
wherein the first set and the second set of advanced ground terminals have ends that extend above top-most ends of the plurality of differential terminal pairs.

2. The connector assembly according to claim 1, wherein the first set of advanced ground terminals are configured to avoid deflection upon contact, and the second set of advanced ground terminals are configured to deflect upon contact.

3. The connector assembly according to claim 1, wherein:
the first set of advanced ground terminals comprises a first advanced ground terminal positioned at a first corner of the first end of the housing, and a second advanced ground terminal positioned at a second corner of the first end of the housing; and
the second set of ground terminals comprises a first advanced ground terminal positioned at a first corner of the second end of the housing, and a second advanced ground terminal positioned at a second corner of the second end of the housing.

4. The connector assembly according to claim 1, further comprising a commoning bar formed of a conductive material, the commoning bar comprising a plurality of projections that engage with apertures in the wafer assembly,
wherein at least a portion of the first set of advanced ground terminals and the second set of advanced ground terminals are conductively coupled to the commoning bar.

5. The connector assembly according to claim 4, wherein the wafer assembly comprises a plurality of grounding components formed of a conductive material, at least a portion of the conductive material being exposed through the apertures in the wafer assembly and being conductively coupled to the commoning bar.

6. The connector assembly according to claim 2, wherein:
the first set of advanced ground terminals comprises a body having a hooked top contact portion and a lower twisted portion positioned parallel to the second end of the housing, and
the lower twisted portion of the first set of advanced ground terminals extends parallel with the lateral side of the hermaphroditic connector and contacts the commoning bar.

7. The connector assembly according to claim 2, wherein:
the second set of advanced ground terminals comprises a body formed of a member extending along a vertical axis of the hermaphroditic connector,
the member has a bent contact portion positioned parallel to the first end of the housing, and
the body further comprises a lower twisted portion that extends parallel with a lateral side of the hermaphroditic connector, the body contacting the commoning bar.

8. The connector assembly according to claim 7, wherein the lower twisted portion comprises inwardly-bent members that pinch the commoning bar therebetween to form an interference connection between the body of the second set of advanced ground terminals and the commoning bar.

9. The connector assembly according to claim 1, wherein:
the hermaphroditic connector is a first hermaphroditic connector and the connector assembly further comprises a second hermaphroditic connector the same as or substantially similar to the first hermaphroditic connector;
the first set of advanced ground terminals of the first hermaphroditic connector is configured to contact the second set of advanced ground terminals of the second hermaphroditic connector; and
the second set of advanced ground terminals of the first hermaphroditic connector is configured to contact the first set of advanced ground terminals of the first hermaphroditic connector.

10. A connector, comprising:
a housing comprising a wafer assembly, the wafer assembly comprising a plurality of terminals;
a first set of advanced ground terminals positioned on a first end of the housing; and
a second set of advanced ground terminals positioned on a second end of the housing opposite the first end, the first set and the second set of advanced ground terminals extending above a top-most end of the plurality of terminals,
wherein the first set of advanced ground terminals are configured to avoid deflection upon contact, and the second set of advanced ground terminals are configured to deflect upon contact.

11. The connector according to claim 10, wherein:
the first set of advanced ground terminals comprises a first advanced ground terminal positioned at a first corner of the first end of the housing, and a second advanced ground terminal positioned a second corner of the first end of the housing; and
the second set of advanced ground terminals comprises a first advanced ground terminal positioned at a first corner of the second end of the housing, and a second advanced ground terminal positioned a second corner of the second end of the housing.

12. The connector according to claim 10, further comprising a commoning bar formed of a conductive material, wherein at least a portion of the first set of advanced ground terminals and the second set of advanced ground terminals are conductively coupled to the commoning bar.

13. The connector according to claim 12, wherein the commoning bar comprises a plurality of projections that engage with apertures in the wafer assembly to retain a plurality of wafers in the housing.

14. The connector according to claim 13, wherein the wafer assembly comprises a plurality of grounding components formed of a conductive material, at least a portion of the conductive material being exposed through the apertures in the wafer assembly and being conductively coupled to the commoning bar.

15. The connector according to claim 12, wherein:
the first set of advanced ground terminals comprises a body having a hooked top contact portion and a lower twisted portion positioned parallel to the second end of the housing, and
the lower twisted portion of the second set of advanced ground terminals extends parallel with the lateral side of the hermaphroditic connector and contacts the commoning bar.

16. The connector according to claim 12, wherein:
the second set of advanced ground terminals comprises a body formed of a member extending along a vertical axis of the connector,
the member has a bent contact portion positioned parallel to the first end of the housing, and
the body further comprises a lower twisted portion that extends parallel with a lateral side of the connector, the body contacting the commoning bar.

17. The connector according to claim 16, wherein the lower twisted portion comprises inwardly-bent members that pinch the commoning bar therebetween to form an interference connection between the body of the second set of advanced ground terminals and the commoning bar.

18. The connector according to claim 10, wherein the first set and the second set of advanced ground terminals extend approximately 1.5 mm above the terminals of the wafer assembly.

19. A connector, comprising:
a housing comprising a wafer assembly, the wafer assembly comprising a plurality of wafers supporting a plurality of terminals;
a first set of advanced ground terminals positioned on a first end of the housing, and a second set of advanced ground terminals positioned on a second end of the housing opposite the first end;
a first commoning bar positioned on a first lateral side of the housing, and a second commoning bar positioned on a second lateral side of the housing opposite the first lateral side,
wherein respective ones of the first set of advanced ground terminals and the second set of advanced ground terminals are conductively coupled to the first commoning bar, and respective ones of the first set of advanced ground terminals and the second set of advanced ground terminals are conductively coupled to the second commoning bar.

20. The connector according to claim 19, wherein each of the plurality of wafers comprises a wafer overmold that comprises openings on each side that exposes an integrated wafer ground structure, wherein the first commoning bar and the second commoning bar are conductively coupled to the integrated wafer ground structure through the openings.
